(19) United States
(12) Patent Application Publication
(10) Pub. No.: US 2014/0109561 A1
(43) Pub. Date: Apr. 24, 2014

(54) Wind To Electric Energy Conversion With Hydraulic Storage

(71) Applicants: Daniel Kenway, Lake Cowichan (CA); Dwayne Garneau, Edmonton (CA)

(72) Inventors: Daniel Kenway, Lake Cowichan (CA); Dwayne Garneau, Edmonton (CA)

(21) Appl. No.: 14/056,194

(22) Filed: Oct. 17, 2013

Related U.S. Application Data
(63) Continuation of application No. 12/813,781, filed on Jun. 11, 2010, now abandoned.
Application No. 12/813,781 is a continuation of application No. PCT/CA2008/002178, filed on Dec. 12, 2008.
(60) Provisional application No. 61/014,002, filed on Dec. 14, 2007.

(51) Int. Cl. F15B 1/02; F15B 1/24; F15B 1/027

(52) U.S. Cl. CPC F15B 1/024; F15B 1/027; F15B 1/24
USPC 60/327; 60/417; 60/416

(57) ABSTRACT

A system for reversible storage of energy, the system comprising: means for generating energy; first conversion means for converting the energy into stored energy by means of low ratio (3.2:1 or less) high pressure (200 bar minimum) compression of gas; and second conversion means for converting the stored energy by expansion or reversal of the first process into usable energy.

### TECHNICAL FIELD

The present invention relates to power conversion. In particular, the present invention relates to use of accumulator storage systems within a hydraulic circuit in the conversion of wind power to electrical power.

### BACKGROUND OF THE INVENTION

It is known to mount a three-bladed rotor on a pilon at an elevation high enough to effectively capture wind energy. Bentz has demonstrated a physical law showing that one cannot extract more than approximately 6% of the power available in the wind through a rotor system. A variety of rotor systems have approximated that. The three-bladed rotor is a good choice as it is suitable for use with commonly encountered wind speeds of between five metres to 15 metres per second. A three-bladed rotor mounted on a horizontal shaft which yaws into the wind is a well-known and well-understood configuration.

Traditional wind energy conversion systems using horizontal is rotors control the amount of energy that is delivered to a shaft by means of stall control or pitch control. Stall control means that the ailerons of the rotors are set to an angle such that, if the wind gusts, most of the surface energy in the wind is converted to turbulence around the rotor blades, thereby protecting the blades, the shaft, the generator, and other system components from sudden transient surges. Pitch control is the feathering of the propeller, the changing of the pitch of the propeller so that the wind effectively has less bite. By means of pitch control, most of the wind passes by without engaging the blade. The combination of these two mechanisms is responsible for the significant loss of energy capture in wind energy conversion systems.

Histograms showing distribution of wind speed versus hours of availability depict curves which likely peak at around eight metres per second for locations that are suitable for wind turbine power generation. However, the energy available in the wind is proportional to the wind speed cubed. The available energy peaks at a higher wind speed, even though the frequency of occurrence of those higher wind speeds is lower. Conventional wind energy systems dump most of this available energy back into the wind because they can't handle it.

Conventional power plants are based on conventional turbines. In the conventional natural gas turbine, natural gas mixes with air, a compressor stage increases the air pressure, there is combustion and the heated air exits through the turbine attached to a generator.

In a compressed air turbine, the compressor section is eliminated, but natural gas is still introduced. The rapid gas expansion thermodynamics cause cooling to approximately −270° C., which causes less stress on the components. Approximately 30% to 40% of the wind energy is converted to electrical energy.

### SUMMARY OF THE INVENTION

The invention comprises means to store energy from the wind or renewable sources (intermittent in nature) by turning the rotary motion of the rotor shut (or primary input shaft) into hydraulic energy, and using that hydraulic energy to compress a gas. The intermittent, dynamic and varying energy of the wind (or other renewable enerby source) is by these means converted into stable potential energy (in the compressed gas) which can be released as is convenient for use (dispatchable electricity from wind power for example).

The invention then (realizing the problems of both scale and absorption of gas into hydraulic liquids) teaches how the problems of scale and fizz may be overcome by using buffers (of gas impermeable liquids buffering normal hydraulic liquids) or mechanical separators, or gas separators within the hydraulic fluid, or alternately chosing special fluids known not to absorb gas.

More importantly, the invention discloses the specific means of “the shuttle”, a piston device with liquids in the central chambers and gases in the outer (or edge chambers) which effectively allows a finite amount of hydraulic fluid to compress or expand an unlimited quantity of gas.

The invention further teaches the fundamental key operation issues that must be controled—that heat exchangers must be provided to remove excess heat from the compressed gas, (and restore heat from ambient to expanded gas), and that the compression expansion ratios of a given “stage” should be limited to approximately 3.2:1 for efficient energy storage and retreival.

The invention further teaches that pipes and tubular steel vessels may be conveniently used as large energy stores for such systems, and that these stores of compressed gas may be conventiently organized in pressure groupings to make storage and retreieval of energy more efficient.

Likewise it teaches that shuttles may be paralleled, so that the irregularities in gas compression or expansion cycles may be smoothed by having multiple shuttles either compressing in parallel, or expanding gas in parallel and this providing a regular and constant sink or source of mechanical energy as the energy is converted to or from potential energy in the compressed gas.

Finally the invention teaches that electronic control of valves and shuttles is required for these machines to be realized.

### BRIEF DESCRIPTION OF THE DRAWINGS

A detailed description of the preferred embodiments is provided below by way of example only and with reference to the following drawings, in which:

FIG. 1 shows the practical arrangement by which variable energy coming from the rotor (remembering that the energy in the wind varies as the wind speed cubed) can be delivered hydraulically to generators with good coupling. The fixed displacement pump attached to the rotor of the wind turbine (or other renewable energy source) produces a pressurized flow of hydraulic fluid which then drives a parallel set of hydraulic motors each of which can be coupled to other energy conversion devices (such as generators). In this way if the rotor is producing only enough pressure and flow for 50 HP, then only the small 50 HP hydraulic motor and generator can be run, whereas if there is more, then the flow and pressure may be convenientlh adjusted to match the energy input available.

FIG. 2 indicates how the key hydraulic energy components may be placed within the wind turbine. The fixed displacement pump (with a supply reservoir) in the nacelle at the top of the wind turbine feeding pressurized fluid flow down (with the depressurized fluid rising back up) via pipes or tubes decending from the nacell to the bas, with the yaw motion of the nacell managed by a fluid rotary union so that the nacelle is free to yaw as it needs to without either flow or pressure loss in the hydraulic lines.

FIG. 3 illustrates an alternate embodiment where the primary pump is mounted at the bottom of the wind turbine, and power transmitted down by means of a rotating vertical drive shaft coming from a right angle gearbox.

FIG. 4 indicates the simplest embodiment of energy storage where hydraulic fluid pressurizes a gas directly mediated only by the separation of a piston in an hydraulic accumulator.

FIG. 5 illustrates the T-2 problem wherein it is advantageous to the electrical grid to be able to “announce” both the commencement and termination of the production of wind energy by wind turbines at least 2 hours prior to “real time”. This is an operational requirement for new wind energy installations in many jurisdictions to allow the ISO (grid operators) to manage the power generated from all sources going into the grid to meet demand without exceeding transmission capacities in any part of the electrical grid. FIG. 5 illustrates how storage makes such T-2 management easily possible, since the stored energy can be released at will, much like all the rest of the dispatchable generation on the grid.

FIG. 6 illustrates a simple embodiment of a system which pressurizes liquid and gas from a renewable source, and harnesses that energy as needed by using the pressurized hydraulic fluid to produce rotating mechanical energy buffered by the storage in the accumulator. Un pressurized fluid is stored in the reservoir of the tank, and pressurized fluid compresses the gas in the accumulator.

FIG. 7 indicates schematically the simple requirements for pipe or tubing which may be used for high pressure gas storage.

FIG. 8 illustrates schematically how as the scale of energy storage increases, the nature of the storage vessels changes, the pipes become large, and the problem of liquid/gas interface becomes accute. In this figure “fizz” is managed by large vertical separators providing gravimetric separation of gas saturated hydraulic oil from the oil which actually turns machinery, since fizz would destroy hydraulic motors and pumps.

FIG. 9 illustrates schematically one of the key inventions, the shuttle. The shuttle avoids fizz (no direct contact of gas and hydraulic liquids) and allows hydraulic pressure to compress and transport gas. Effectively the shuttle is the key element to an “infinite accumulator”.

FIG. 10 teaches schematically of the necessity for electronically (or computer) controlled valves on both the gas and hydraulic flow streams so that the shuttle can continuously pump and compress, or be pushed by moving and expanding gas and drive hydraulic fluid.

FIG. 11 illustrates a portion of a gas compression cycle, showing how the valves must be set, and how the piston moves.

FIG. 12 illustrates that the shuttle may be designed with different ratios of liquid to gas surface areas on the pistons, thus allowing for appropriate use in different parts of the compression cycle (larger gas chambers to smaller liquid chambers at low gas pressure regimes—near atmospheric pressures), and small gas chambers in relation to the liquid chambers at higher pressure regimes.

FIG. 13 illustrates a rotary embodiment of a hydraulic pressure/flow conversion device—a hydraulic transformer. Effectively two variable displacement hydraulic pumps/motors may be coupled on the same shaft, and depending on the volume of each pressure P1 with flow Q1 may be transformed to pressure P2 with flow Q2 where the ratios D1\D2=Q1\Q2=P2\P1 are all consequent to this arrangement where D1 and D2 are the displacements (volume per rotation) of the two pumps. This transformation element is necessary to equalize pressures within the system since the wind turbine may be operating at one pressure, and the gas storage system at quite another.

FIG. 14 is an illustration of how heat exchange can be built right into the shuttle structure to make the gas compression/expansion more isothermal, and more efficient.

FIG. 15 is an illustration of how small accumulators may be attached to the high and low pressure liquid hydraulic fluid lines, to minimize “shocks” to the hydraulic system as the shuttle valves repeatedly switch.

FIG. 16 illustrates how parallel shuttles may all be arranged to be at different phasing to allow for a smoother overall operation.

FIG. 17 illustrates how multiple parallel sets of shuttles may be used to manage different pressure relationships, for example one set with lower liquid pressures, and a different set with higher liquid pressures, each set having different mechanical advantage in the ratio of liquid to gas piston surface areas.

FIG. 18 schematically illustrates how multiple gas pads each at a different storage pressure, may be used to allow stable operation under a variety of wind speeds and operating conditions.

FIG. 19 schematically illustrates how multiple wind turbines may share common storage resources by merely sharing pipe. The hydraulic and gas pipes becoming part of the energy transmission system over the wind farm.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The use of hydraulic circuit power conversion offers several advantages in systems for electrical generation from wind power. In the prior art, generators have been mounted in proximity to a wind turbine to avoid energy loss. In the embodiments of the present invention, if the pump is on top of the tower hydraulic energy is easily delivered through hydraulic swivels or by means of a mechanical shaft extending to ground level. With the energy and the hydraulic system at ground level and the capacity to store energy within a hydraulic system, the control of the generation of electrical power becomes much simpler.

In traditional wind turbine designs it is common to use a costly, high efficiency annular DC alternator. Such an alternator is a complicated element, difficult to control, and situated at ground level. In contrast, in the present invention, with most of the energy in hydraulic form, it is possible to use very low displacement hydraulic motors to draw off power contained within the hydraulic circuits. Even without an accumulator, with proper selection of the size and number of hydraulic motors in a manifold arrangement, it is possible to match the motor generator load to the available wind energy.

For example, one or more 50, 100 or 150 horsepower generators may be placed in parallel arrangement with variable displacement hydraulic pumps on each generator. The power stored within the hydraulic fluid will be distributed among the pumps according to the pump displacement available. On each of the hydraulic pumps, the displacement would be controlled by a proportional-integral-derivative (“PID”) controller or similar control device that provides for a uniform rotational speed appropriate to the synchronous generator. For example, for synchronous generators operating at 60 hertz, as is commonly found in North America, the rotational speed may be 1800 rpm. For synchronous generators operating at 50 hertz of rotational speed, it may be 1500 rpm.

In operation at low wind speed the displacement of the on/off valving and variable displacement on the smallest motor generator initially would be set so that the generator turned at slightly more than 1800 rpm, for example, 1805 rpm, to begin to generate power of approximately 35-40 kilowatts. If the wind speed increases, it would be possible to open up the displacement of one or more of the other generators and generate power at an appropriate back pressure and back torque for the wind turbine. Depending on the amount of energy that is available in the energy store and the generating capacity chosen, it is possible to deliver stored power that has been generated by the wind during the preceding period into the grid at a later time of optimum price and with the predictability required by the grid.

According to the present invention, there is provided a system and method for conversion of wind power to electrical power by means of a hydraulic circuit. More specifically, storage systems within the hydraulic circuit in the form of accumulators or gas compression expansion systems designed to operate at high pressures and low compression ratios are used to temporarily store power to permit use of the stored power at an optimal time. It is the details of the accumulator/gas compression/gas expansion system that distinguish this invention from what has been previously taught. The energy storage system must function on a massive scale, and needs to operate at greater efficiencies that those currently known. The accumulators may be pistonless accumulators, or may employ a system of shuttles and compressed air pressure tanks.

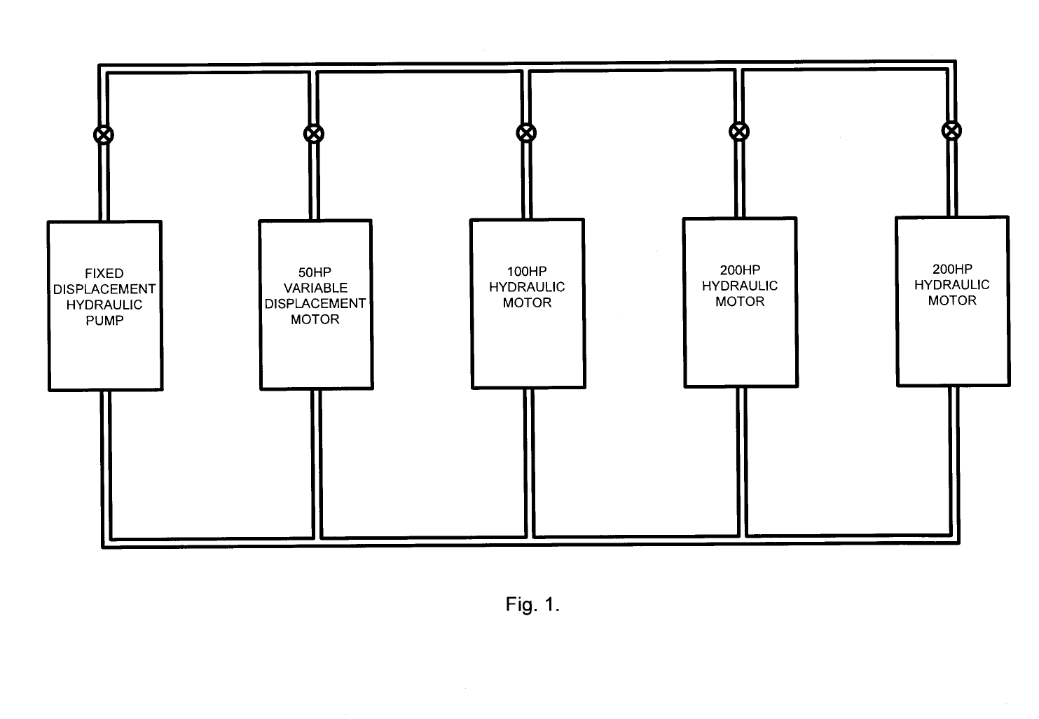

In one embodiment of the system of the present invention, as depicted in FIG. 1, a fixed displacement hydraulic pump is mounted at the top of a tower structure with its shaft in a horizontal orientation. An appropriate tank is situated above the hydraulic pump to provide hydraulic fluid to the hydraulic pump. In the embodiments in which the hydraulic pump is at the top of the tower, it is necessary that there be a hydraulic fluid reservoir above the pump and additional safety interlocks so that if there is a rupture of the hydraulic circuit coming down from the pump, there is a stable path for the oil, and the components will not be damaged.

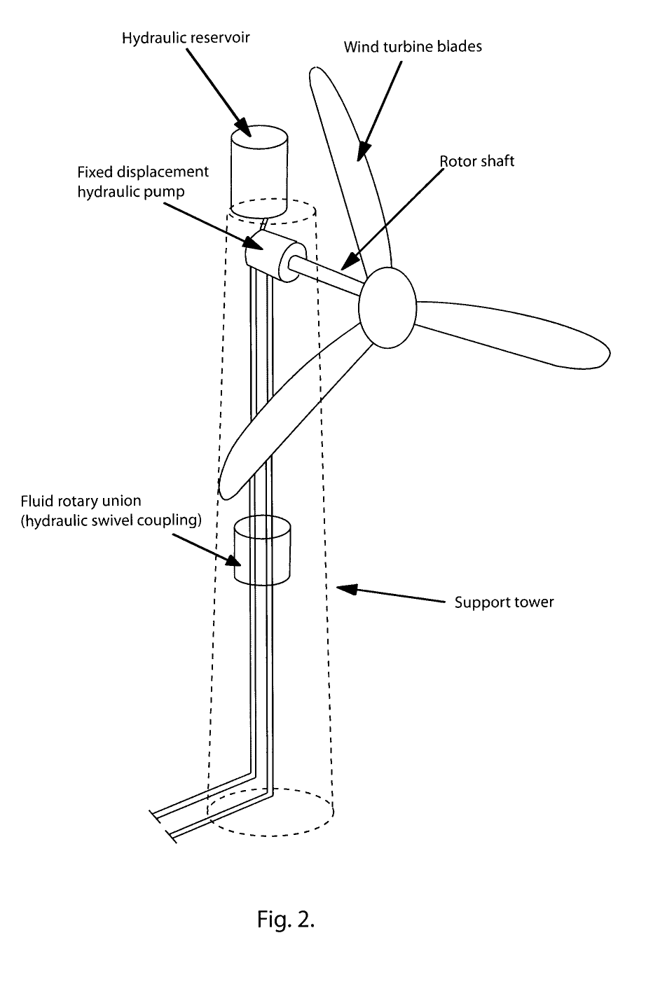

In another embodiment of the system of the present invention, as depicted in FIG. 2, an angled gear box is located at the crown of the tower structure. The angled gear box transmits the rotary energy, which has been converted from wind energy by a wind turbine blade, to a vertical shaft.

In both of the foregoing embodiments, there is conversion by the hydraulic pump of rotary energy into hydraulic energy in a hydraulic circuit. Hydraulic energy is determined by volume and pressure within a hydraulic circuit. The energy available for storage or use is the product of volume and pressure. In a hydraulic circuit, back pressure can be controlled, which works against the primary conversion pump. Therefore, the energy stored in the hydraulic circuit may be used to start the rotors independently even at very low speed and, having overcome starting inertia, then allow for very low back pressure, so that energy can be gathered from low wind regimes.

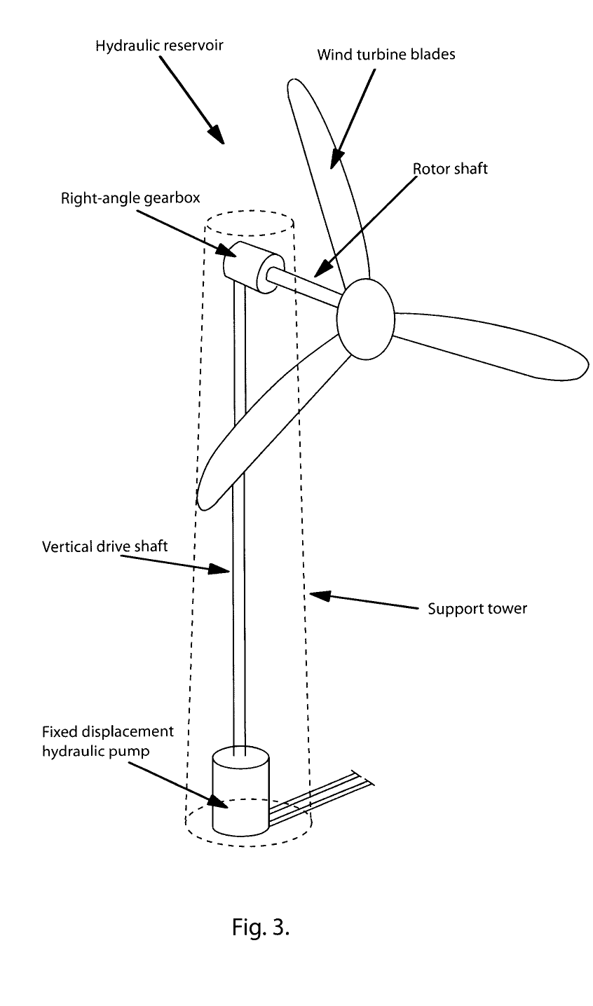

The system of the invention further comprises one or more accumulators for energy storage. In its simplest form, as shown in FIG. 3, an accumulator is a device having a central piston with hydraulic fluid on one side of the piston and trapped gas on the other side of the piston. As the hydraulic pump moves hydraulic fluid into the fluid side, the piston is driven towards the gas side, thereby compressing the gas, increasing its pressure to store potential energy in the form of gas pressure. One use of an accumulator is to take pressure surges out of a system. An accumulator also may be used for short-term storage of fluid energy in a hydraulic system.

With the availability of hydraulic accumulation, rotors can be coupled directly to a hydraulic pump and the pump to an accumulator so that short-term wind gusts and variations may contribute to the amount of energy captured.

Approximately 10 to 20 seconds of storage by hydraulic accumulation would be required for managing short term wind gusts. However, accumulation may be used on a much larger scale to permit longer term energy storage. Such longer term storage is highly desirable to address challenges presented by wind speed variability. Wind speed variability is a problem encountered in electrical power grids around the world. Because of the variability of wind power, it is difficult to deliver this type of power to these electrical grids.

An electrical power grid is a high intensity capital resource of limited capability which is only able to receive and transmit power within specific parameters. Accordingly, in order to add wind power to a grid having conventional generator sources, such as coal, oil, natural gas, or nuclear power, some of this conventional generating capacity already on the grid must be shut down in order for the grid to add the wind power. This limitation has inhibited use of wind power because a certain period of time is required to shut down these other generation resources. For example, some jurisdictions require a two-hour notification period before wind power may come online, to permit other power generating facilities to be shut down or managed in a predictable fashion.

It is possible to build accumulators sufficiently large so that up to two hours capacity may be stored. Use of large accumulation significantly changes the cost and utilization advantages of wind power. The power may be delivered when it is required rather than when the wind blows and it is generated. Electrical utilities very often have peak loading during the early morning hours or during the early evening hours, when people are cooking breakfast or dinner. This is the time when power is at its greatest premium, therefore its highest cost, yielding the greatest return to those who sell wind power and the greatest utility to those who wish to use power. Two-hour storage within the accumulation system makes it possible to greatly improve the advantages of wind electric generation.

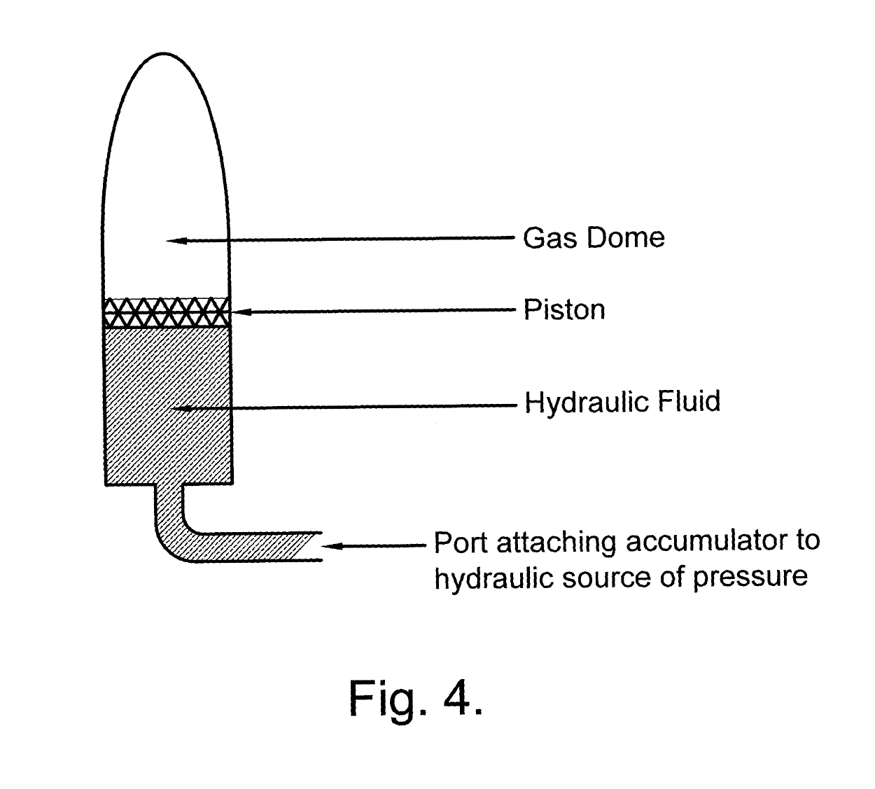

For example, for a jurisdiction requiring a 2-hour notification period, as depicted in FIG. 4, as wind speed at a wind generation site achieves a threshold to permit a wind turbine to commence electricity generation, notification may be provided to the grid. Power delivery to the grid would commence two hours after the threshold was met, and continue for two hours after the threshold wind power ceased. The final two hours of power delivery to the grid would be delivery of power stored by the accumulation system.

In a traditional compressed air energy storage system, compressed gases are stored in large reservoirs, often underground, and the energy within the compressed gas is released through decompression within a modified gas turbine. The decompression cycle usually includes the burning of small amounts of natural gas to maintain an appropriate temperature and pressure regime to achieve maximum. efficiency from the conversion technology. The present invention differs from such systems in that, with storage by an accumulation system, the transfer of energy from a compressed gas state to a generation state is accomplished merely by reversing the accumulation process.

The recovery of energy from the accumulation system results from allowing the gas to push back against the pistons in the hydraulic accumulator. The piston-driven hydraulic fluid will drive the generator as it would have in the non-storage case for hydraulic implementation. This offers improved energy conversion efficiency, since there are no change of state elements required.

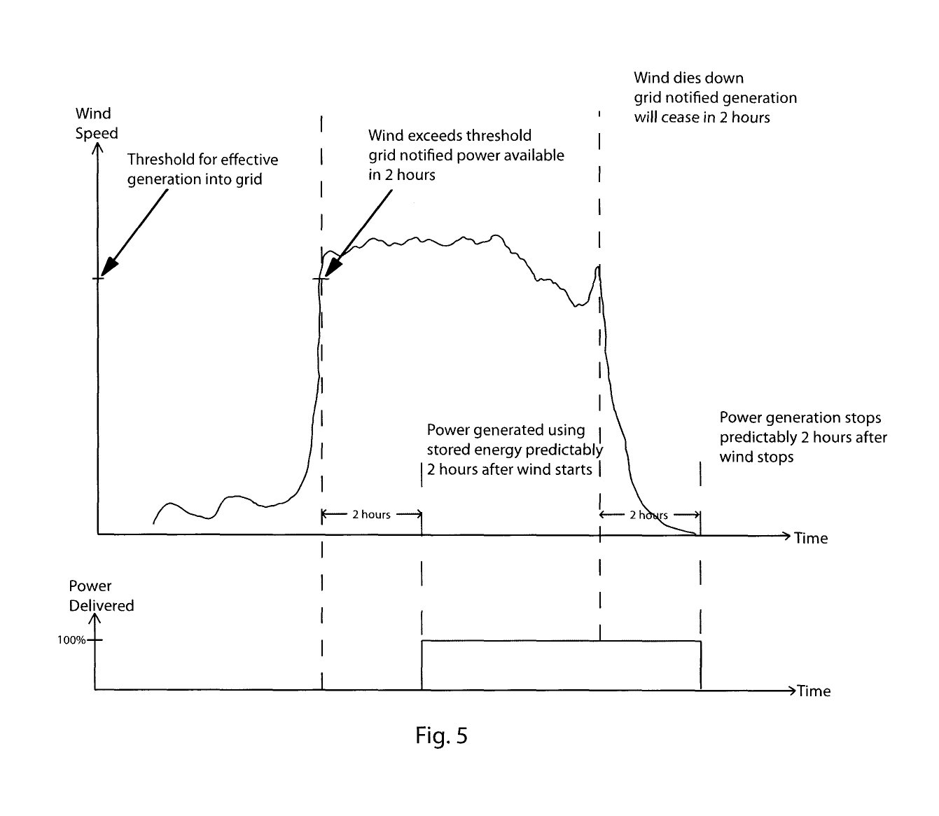

An accumulator in its simplest form as depicted in FIG. 5, comprises an hydraulic circuit having a piston as a separator between an inert gas and a hydraulic fluid on the high pressure side, and a reservoir on the low pressure side. The reservoir may be pressurized to between 2.5 and 3 bar. Pressurization of the reservoir is required because available fixed displacement pumps, such as the Hagglunds pump; require some pressure in the case to maintain contact between the pistons and the cams that move the pistons. For a two-hour storage system, a reservoir capacity of hundreds of thousands of litres of liquid would be required. Although it is possible to build piston accumulators to such a scale, they are not practical. One embodiment of the invention is to use pistonless accumulators.

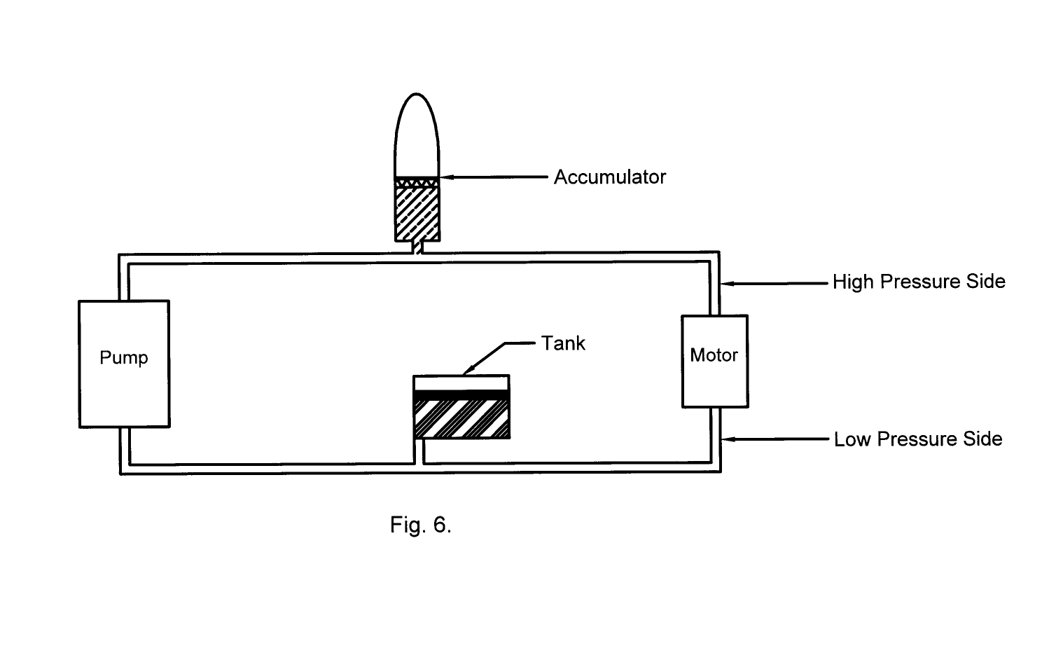

One cost-effective means of storing energy in a pistonless accumulator may be found in the oil industry. As shown in FIG. 6, pipeline from the oil industry is a hollow cylindrical material which has a half-inch steel wall, tapered ends and diameters of up to 42 inches, at relatively low cost. This material is capable of supporting up to 5,000 psi. Approximately 15,000,000 joules per metre may be stored with this basic pressure vessel.

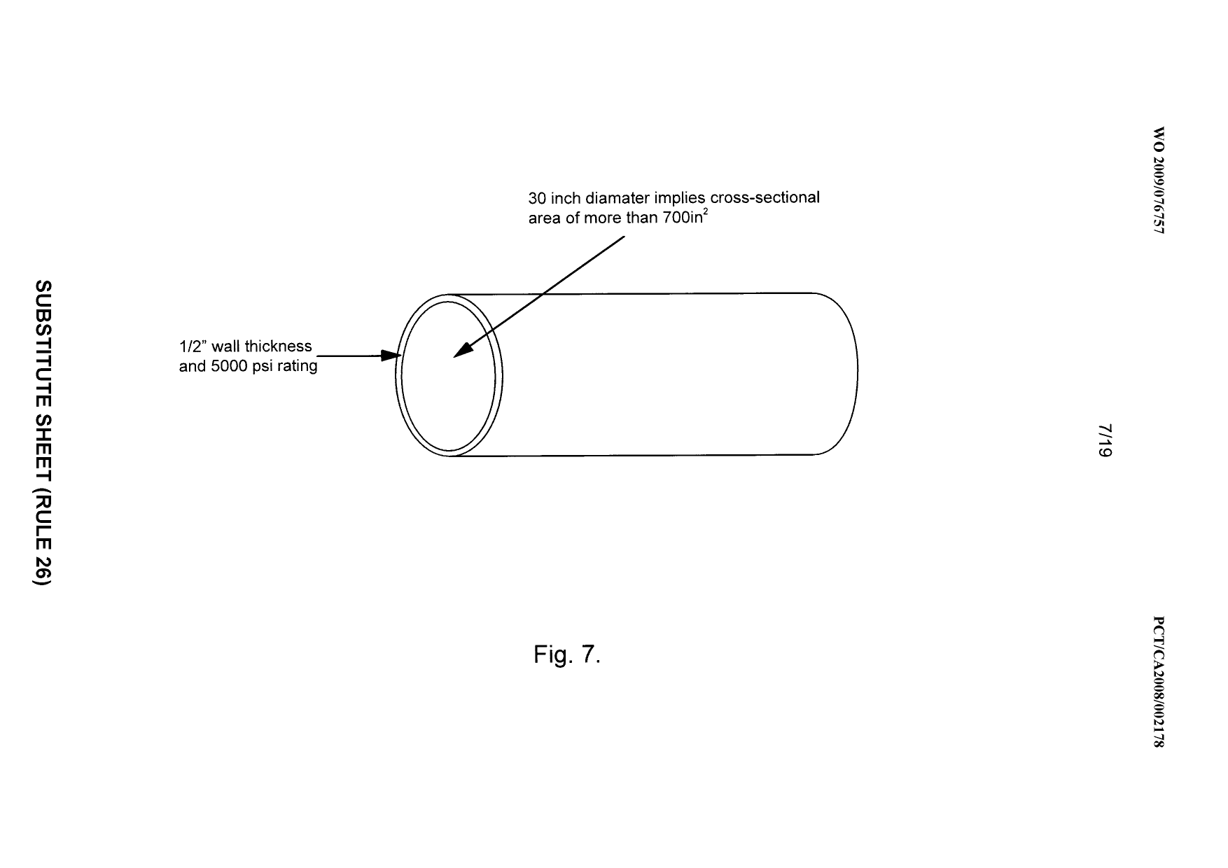

In one embodiment of the invention, the pressure vessel may be constructed of long segments of glass wrapped steel or plastic. The accumulator may take the form of a gas pad which snakes its way back and forth on the surface of a wind farm site, and which contains a large volume of air under pressure. Hydraulic fluid is necessary to pressurize the air in a pistonless accumulator. In this embodiment, as shown in FIG. 7, lengths of horizontal pipe may be threaded together with vertical gas separators at the outlet of each reservoir. Gas separators would comprise vertical elements placed below the level of the pipe element so that hydraulic fluid on both the low-pressure reservoir and the high-pressure reservoir would completely fill the vertical sections and extend outwardly over a long distance in the horizontal sections.

If, for example, the low-pressure section were two-thirds full of fluid in its horizontal length and the high-pressure section were one-third full, the displacement of fluid from the low-pressure side to the high-pressure side would reduce the accumulation pressure on the low-pressure side by a factor of 2 and correspondingly increase the accumulation pressure on the high-pressure side by a factor of 2. As the pressure on the low-pressure side dropped, for example, from 5 bar to 2.5 bar as the gas volume increased, the pressure on the high-pressure side would increase from, for example, 150 bar to 300 bar in a pressurized state. Maximum pressure in the pistonless accumulator would be limited to below the rupture pressure of the pressure vessel.

It is important to minimize gas absorption by the hydraulic fluid in such a system. Highly pressurized air bubbles in a hydraulic system may cause damage when they pass with the hydraulic fluid into low-pressure areas and may expand. Traditionally, pistonless accumulators are constructed as long cylindrical pressure vessels having a vertical orientation to minimize the surface area in contact with the gas in the vessel, thereby limiting the extent of gas absorption by the fluid.

Additional measures are known to minimize gas uptake by the hydraulic fluid. Floats may be used to further reduce the gas/liquid interface contact area. In U.S. Pat. No. 5,021,125, Phillips et al. teach incorporation in vertical sections of the accumulator of design elements which provide substantially laminar hydraulic fluid flow. The gas-impregnated oil, being lighter, tends to remain near the top of the vertical section where the gas may be discharged back into the accumulator before the hydraulic fluid is extracted from the accumulator into the hydraulic circuit.

Another embodiment of the invention is to use a low gas absorption hydraulic fluid, which will absorb significantly lower levels of gas. An example of such a fluid is EXXCOLUB™. With such a fluid, the gas air interface size is not of concern. In an alternate embodiment, the low-pressure side may be pressurized to between (50 and 100)? bar with hydraulic pumps and motors enclosed in pressure vessels able to withstand such increased pressure and with rotary seals for their shafts so that the case pressure to atmospheric pressure for both those elements would be approximately 3 to 5 bar.

In an alternate embodiment of the accumulator structure, to avoid use of large volumes of hydraulic fluid, a hydraulic shuttle may be used to move gases and hydraulic fluids efficiently. This arrangement may act as both a compressor and a pump to allow gas to be drawn from a low-pressure reservoir, compressed, and moved into a high-pressure reservoir. The compression ration between the low pressure reservoir and the high pressure reservoir is restricted to a ratio of approximately 3.2 to 1. In the compression schemes that have been previously taught to us, gas pressures begin at one atmosphere with the compressed gas reaching a maximum pressure of 100 atmospheres. This high ratio of compression is typically achieved by four stage inter-cooled compressors which waste most of the heat generated. As a result the compression process is neither adiabatic nor isothermal and therefore the storage recovery efficiencies are extremely impaired.

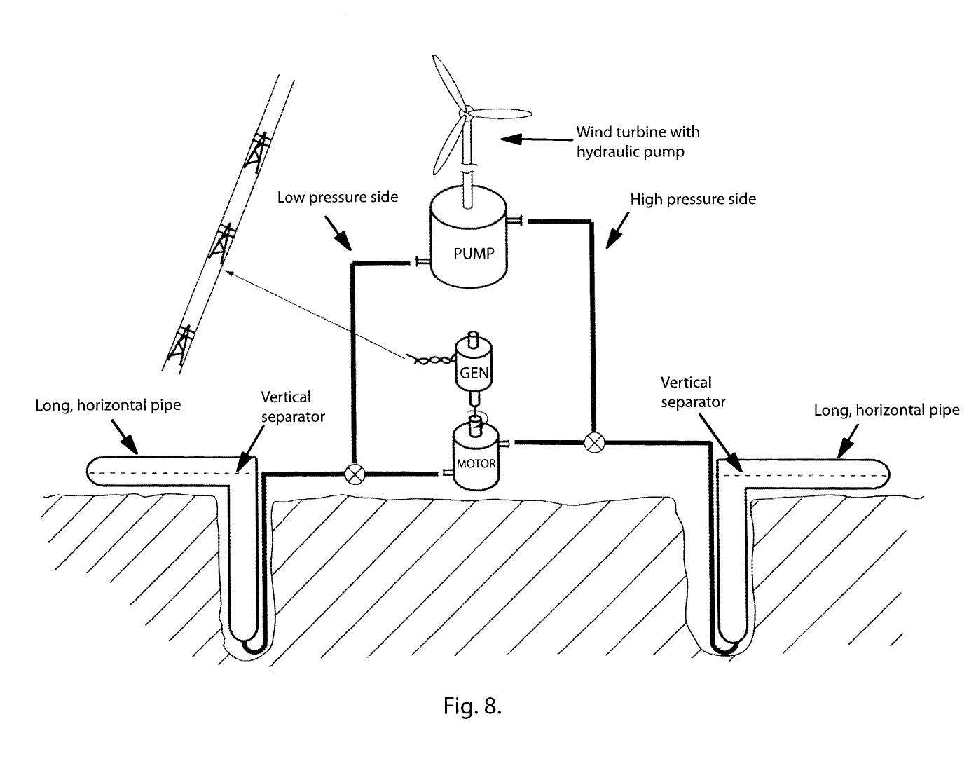

One embodiment of such a shuttle is depicted in FIG. 8. The shuttle may consist of a cylinder segmented into four parts. In the centre may be a differential hydraulic cylinder having a first chamber on one side accepting low-pressure hydraulic fluid, and a second chamber on the opposing side accepting high-pressure hydraulic fluid. On opposing ends there may be corresponding first and second gas cylinders attached to the same rod so that if differential high pressure is applied from the hydraulic side, the gas in one chamber will be compressed and the gas in the other chamber will be expanded, drawing in gas from the gas cylinder then connected to that chamber.

A first gas port may selectively connect the first gas cylinder to a gas reservoir and a second gas port may selectively connect the second gas cylinder to a gas reservoir. A first hydraulic fluid port may selectively connect the first chamber to a hydraulic fluid source and a second hydraulic fluid port may selectively connect the second chamber to a hydraulic fluid source.

According to one embodiment, in an initial configuration the shuttle may be in a position in which the piston is fully displaced into the first chamber, such that the first chamber has minimum volume and the second chamber has maximum volume. The first gas port may be connected to a low-pressure reservoir with the valve open; the second gas port may be connected to a high-pressure reservoir with the valve closed; and the hydraulic fluid ports may be connected so that the high-pressure hydraulic fluid moves the cylinder towards the second chamber.

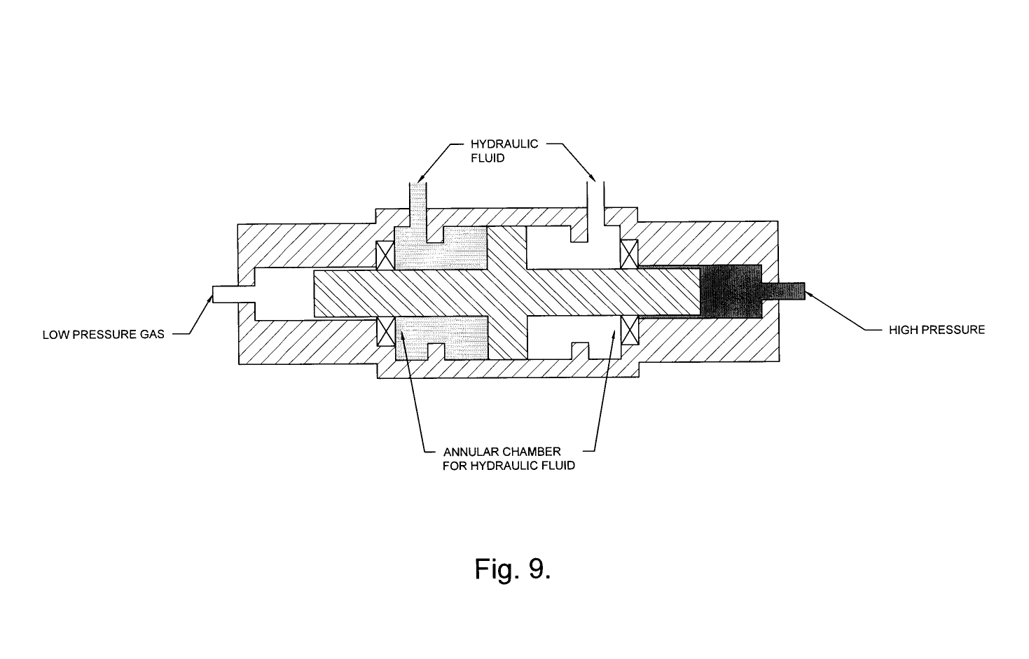

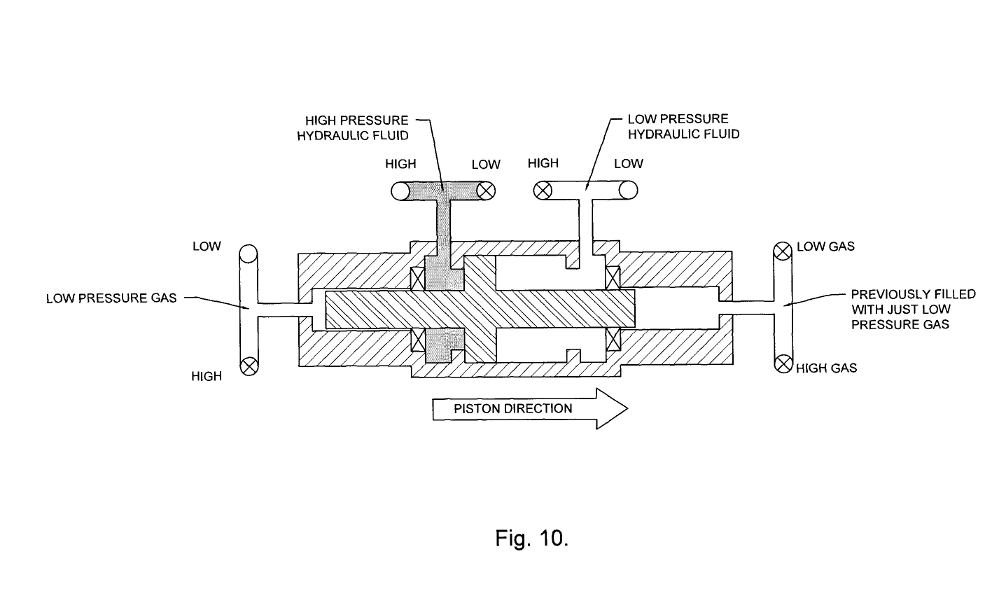

In one embodiment of a method of hydraulic energy storage, commencing with the shuttle in the initial configuration depicted in FIG. 9, and with the pressure in the first and second chambers equal to the pressure of the low-pressure reservoir, the hydraulic fluid is permitted to drive the piston into the second chamber, as depicted in FIG. 10.

The high-pressure hydraulic fluid will drive the piston to compress the gas in the second chamber while drawing gas into the first chamber to fill the void left by displacement of the piston from the first chamber. The pressure in the second chamber will rise. Once the piston has moved sufficiently that the pressure in the second chamber is equal to the pressure in the high-pressure reservoir, perhaps two-thirds of its stroke if the pressure differential is not too great, the second gas port valve may be opened. The piston will then act as a pump, instead of a compression element, moving the pressurized gas from the second chamber into the high-pressure reservoir, as well as continuing to provide compression.

When the piston is fully displaced into the second chamber, the connections of the conduits to the ports may be blocked, then reversed. Local accumulators on the gas system and the hydraulic system may be provided to minimize switching transients, in order to avoid hydraulic pressure or gas pressure shock. The next phase of the method would proceed as described above, but in the reverse direction with the reversed fluid connections. The piston would compress the low-pressure air in the first chamber for perhaps two-thirds of the piston stroke, the first gas port valve would be opened, and the piston would move the high-pressure gas in the first chamber into the high-pressure reservoir while continuing compression. In this manner, the amount of hydraulic fluid flowing between the high-pressure side and the low-pressure side would remain balanced while air would be pumped from the low-pressure reservoir to the high-pressure reservoir, storing energy.

To extract energy from the high-pressure reservoir, the pressure of the gas may be used to drive hydraulic fluid through hydraulic motors to generate electrical energy. With proper control, the pump and the accumulator system may work independently or in parallel so that momentary transients can be absorbed.

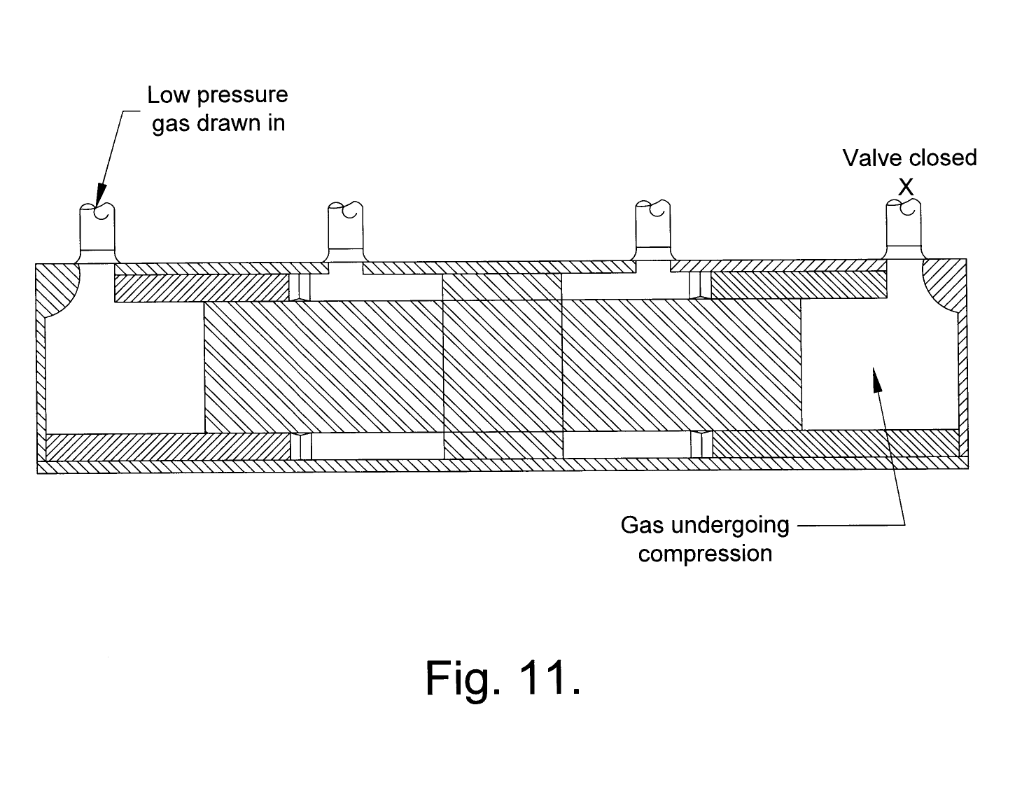

According to an alternate embodiment, as depicted in FIG. 11, a piston having a different surface area in contact with the hydraulic fluid side than its surface area in contact with the gas side may be used. The differential area created by changing the diameter of the gas chambers, would make it possible to change the mechanical advantage of the system so that the hydraulic pressure difference required to move the shuttle may be lower.

This arrangement permits use of a fixed displacement hydraulic pump to store energy from low velocity wind. A fixed hydraulic pump provides a resistance that is proportional to the pressure difference encountered in its pumping circuit. At low wind velocities there is much less energy in the wind. Selection of shuttles which, by virtue of the differential piston surface areas, have a greater hydraulic-to-gas advantage, make it possible to lower the resistance on the hydraulic motor shaft, allowing the rotor to turn more easily under low wind energy conditions while storing energy at the optimum rate.

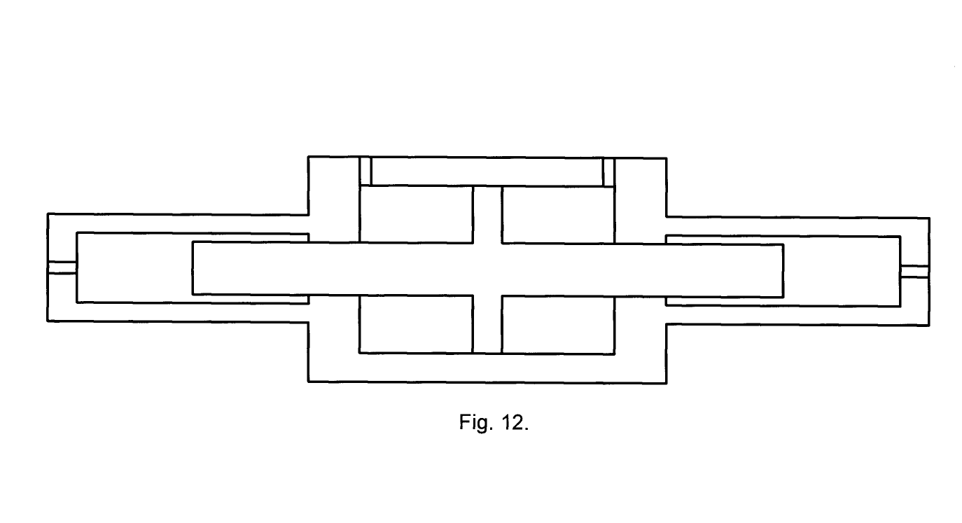

In order that any heat loss is equilibrated, in a preferred embodiment as depicted in FIG. 12, a heat exchanger may move heat from one reservoir to the other so that the heat produced from air compression is transferred and distributed to offset cooling in the decompression side.

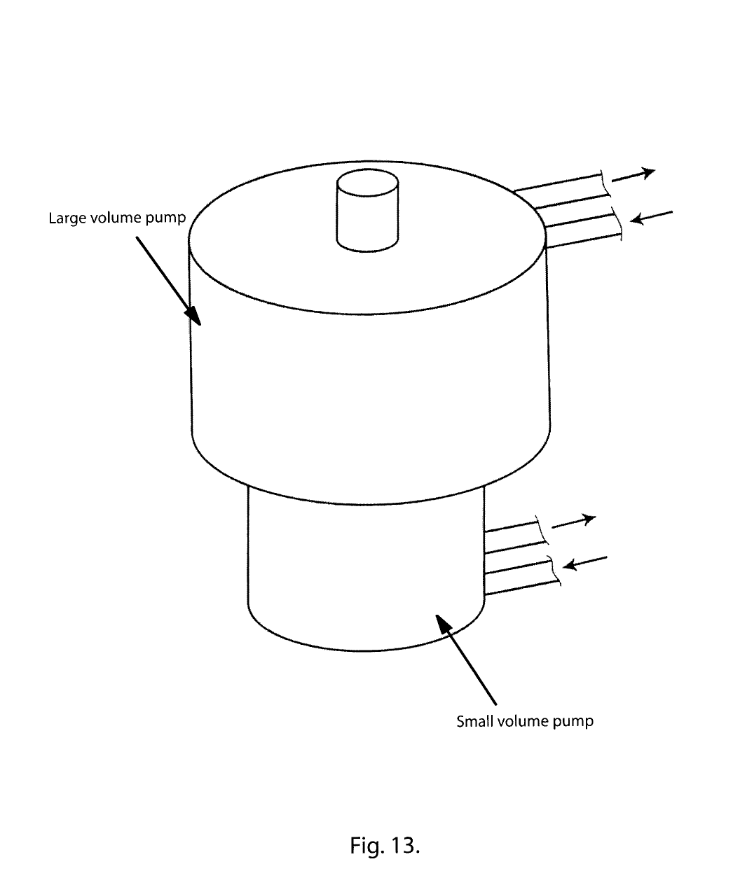

In another embodiment of this invention, as depicted in FIG. 13, in addition to the shuttle circuit described, medium-sized accumulators of sufficient volume to absorb 30 seconds of maximum hydraulic pump output may be provided on both the high-pressure and low-pressure sides of the accumulator to provide flexibility in switching times.

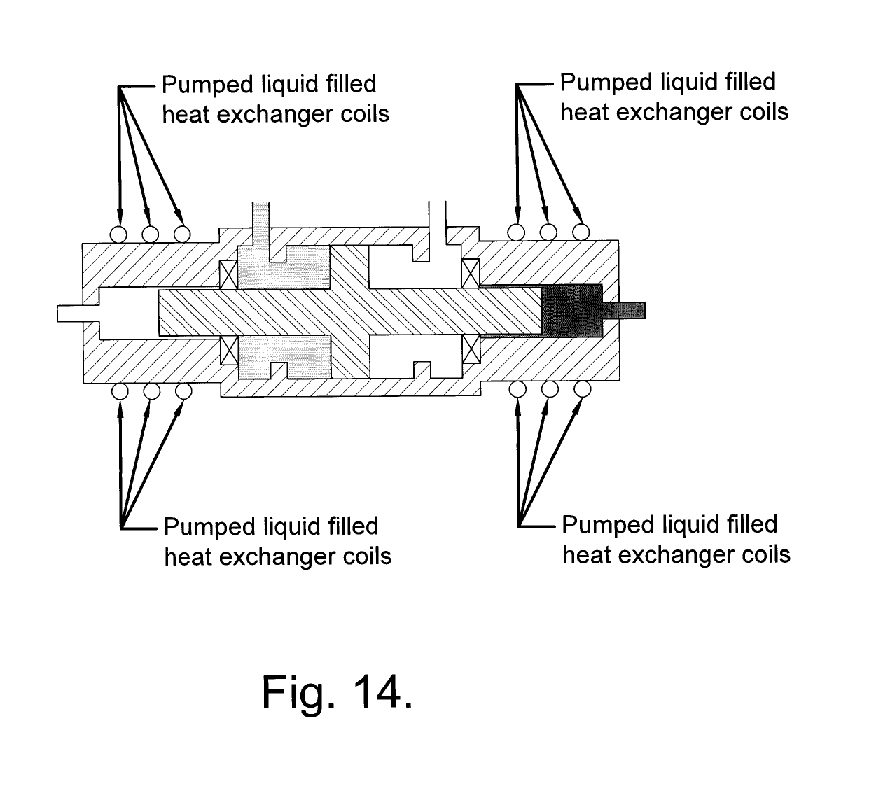

In another embodiment of this invention, depicted in FIG. 14, a set of a plurality of shuttles may be used. For example, in an embodiment having a set of three shuttles, it is possible to arrange the three shuttles such that there will always be one shuttle in a desirable position and pressure regime to travel from the first chamber towards the second chamber, one shuttle balanced and traveling in the middle between the first and second chambers, and one shuttle in a desirable position and pressure regime to travel from the second chamber towards the first chamber. Sequencing of the three shuttles may be controlled so that as any one of the shuttles nears its terminus, another shuttle that is in mid-stroke may be operated in parallel with the shuttle nearing its terminus so that there is always at least one shuttle which offers easy displacement to absorb or discharge energy.

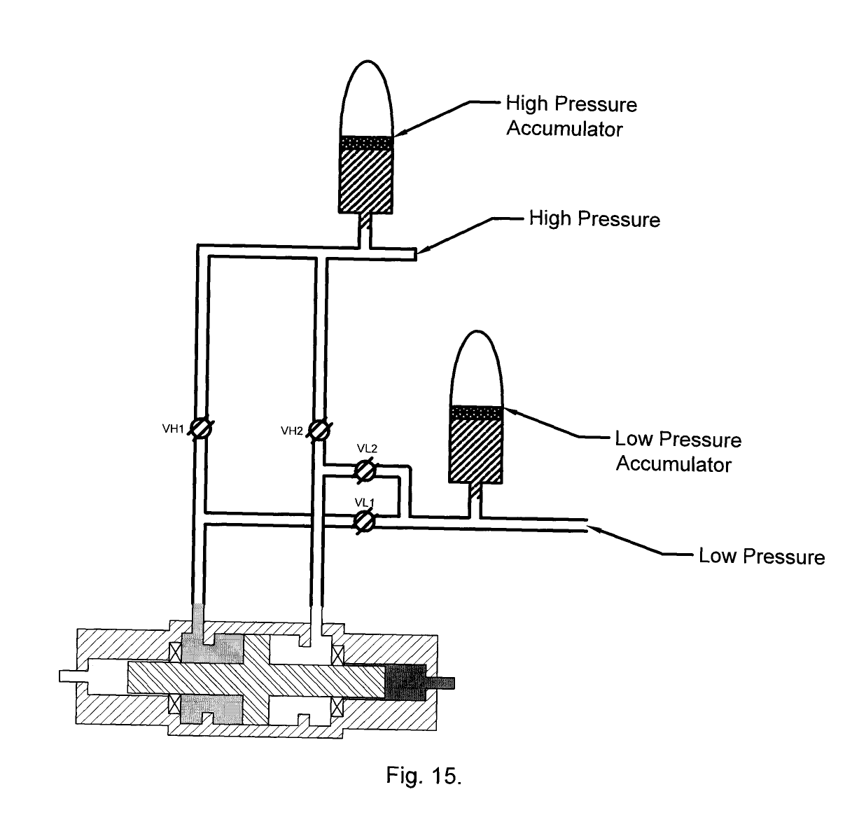

In an alternate embodiment, as depicted in FIG. 15, there may be more than one multiple shuttle set, a first set with a mechanical advantage intended for high-power winds; and a second with a much greater mechanical advantage so that low-velocity winds could easily compress the gas at a lower hydraulic pressure, although the gas pressures would remain the same. More than two shuttle sets are also contemplated to be within the scope of the present invention.

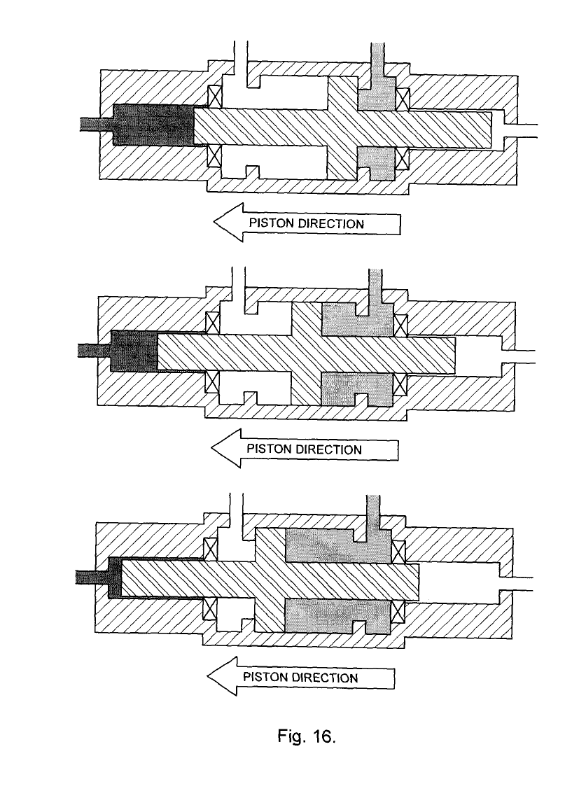

In still another embodiment, as depicted ion FIG. 16, several gas pads may be available at different stepped pressure regimes. For example, one may be at 330 bar, one at 150 bar, one at 50 bar, and one at 10 bar, permitting selection of the optimal storage and discharge regimes appropriate to the wind and power generation conditions present.

Additionally, in another embodiment of the invention, there is provided the use of emergency valves in the hydraulic circuit to provide stopping force for the wind turbine. While braking systems for wind turbines are a complex art, one of the simplest forms of braking is simply to drop the pressure across the hydraulic pump, which will cause extremely high back torque on the hydraulic motor. This, of course, while heating both the valves and the hydraulic fluid, will provide a simple, stable and safe way to reduce rotor speed under high wind conditions to enable the controlled application of disk or other braking systems.

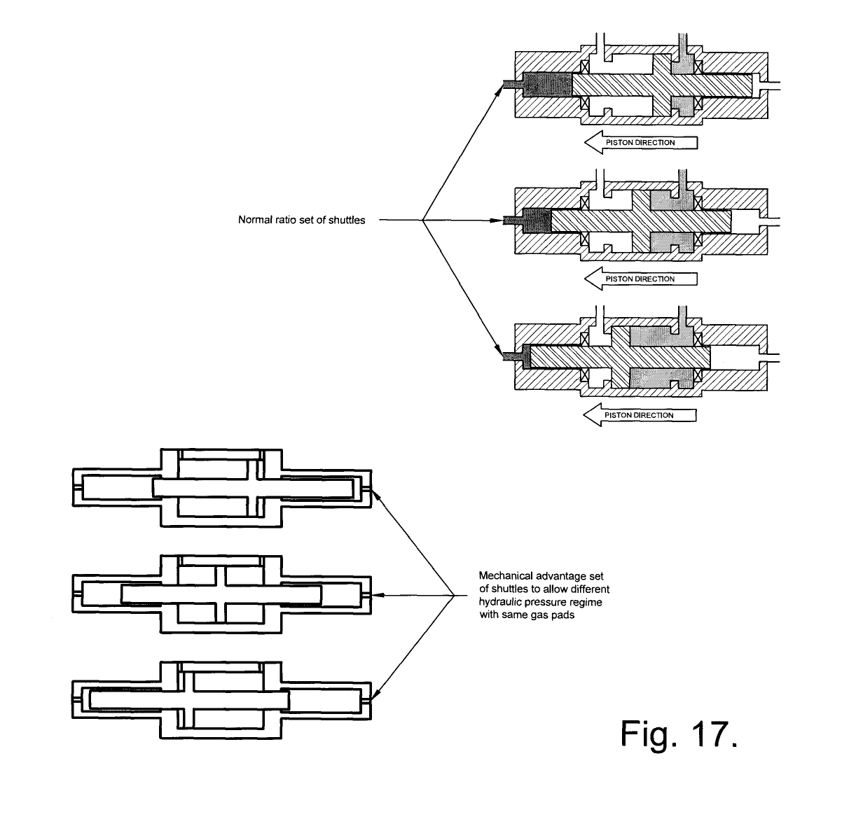

In another embodiment of this invention, as shown in FIG. 17, the hydraulic energy storage and hydraulic-to-electric power conversion may be common resources shared among several turbine towers in a wind farm. In another embodiment of this invention, the control of several towers sharing a common hydraulic-to-electric conversion resource and common storage may also be commonly managed.

While in a conventional hydraulic control system, in order to dissipate both the heating from the braking as well as other heating generated in the hydraulic circuit, a heat exchanger must be provided, with the present invention, because of the high transient energy absorption available, it is possible to use more aggressive blade pitches on the propeller so that even as the three-bladed propeller rotates, the lowest blade in the least amount of wind may be aggressively pitched to capture the most energy, as there is capacity both to convert and buffer all of the wind energy available from the blade system, to the limits that the blade can withstand.

In another embodiment of this invention, the pitches and blade sizes of some of the wind turbines designed to operate with maximum efficiency in lower winds, whereas others are chosen to operate at maximum efficiency in higher winds. In this way, the common resources of energy storage and hydraulic-to-electric power conversion may be shared among multiple towers, thereby offering a more effective use of capital and equipment.

It will be appreciated by those skilled in the art that other variations of the preferred embodiments may also be practiced without departing from the scope of the invention.

In another embodiment of the invention the means of energy storage use compressors—like the Arial piston compressor—to move gas from the low pressure reservoir to the high pressure reservoir as the gas is compressed. The compression ratio employed would be the same as with the shuttle system—in the range or 3.2 to 1 as opposed to the 100 to 1 ratios commonly used.

With a change in valving to PLC controlled electromagnetic valving such piston compressors may also be used as expansion engines. The expansion engine is used to recover the energy in the pressured gas. Wince the gas has been pressurized at a low ration the temperature. increase in the gas may be tolerated by both the compression and expansion components, and so the compression expansion process becomes essentially adiabatic.

In another embodiment of the invention the expansion is achieved by using computer timing to control rapid acting solenoid valves which drive independent cylinders each of which cranks a common driveshaft,

The compression expansion scheme proposed here follows the logic of Merswolke et al. (U.S. Pat. No. 6,718,761) with several key differentiations. While Mersewolke anticipates the use of compression, it is not practical in that the energy losses in the scheme he proposes are not practical. Only by using dual storage tanks (low and high pressure) relatively high pressure regimes (3000 psi plus) and low compression rations (3.2 or less) is it possible to achieve the high efficiency quasi-adiabatic results of the current invention.

Merswolke does not teach any of these critical elements.

Likewise the use of electromagnetically driven, computer or PLC controlled valuves in the compression elements is not anticipated.

The current invention also avoids many of the pitfalls of the current art by providing for wireless controls of pitch, braking and all key operational elements of the wind turbine. Existing designs have had to transmit power to the ground level by means of large electrical cables. The current invention transmits power by means of either a vertical driveshaft, or pressured hydraulic fluid which arrives at ground level as it passes through a fluid rotary union.

Accordingly the current invention incorporates separate control systems for pitch control in the rotating hub, horizontal shaft braking in the crown, yaw control beneath the crown, and power conversion and storage control at ground level.

All of these control systems communicate by wireless network.

Storage batteries are provided at the crown, in the hub and at ground level so control is available at all times and under all conditions.

Solar panels are provided at crown and ground level to trickle charge these electrical control systems. Shaft power from the primary shaft is coupled to small generators (for example 24 volt 100 amp) in the crown to provide ordinary control power aloft.

The invention specifically embodies the use of stacked hydraulic pumps mechanically separated by clutches (like the National Air clutch found in drilling rigs) to provide a greater range of torque as wind speed varies. It is a feature of the current invention to maximize the utilization of the airfoils by effectively using the hydraulic pumps and motors as a transmission between the low rpm primary shaft on the horizontal axis wind turbine, and the higher rpm shafts driving generators or air compressors.

It is also a feature of the current invention that the pipeline storage of the energy in the compressed gas may be used as a means of power transmission over entire windfarms comprising 10's or hundreds of miles.

Since the wind turbines are all computer controlled the dispatchment of power may be effectively concentrated in large power houses containing many shuttles or expanders. Each shuttle or expander will drive an independent synchronous generator, but the control of the dispatchment of the stored energy to the electrical grid may be optimized to capture peak price per kilowatt hour conditions (since the computer control can optimize for price).

It is a further feature of the current invention that not only pitch and yaw may be optimized on the basis of information acquired from external anemometers, but also dispatchment rationing to conserve power in remote sites during seasons of low wind.

Cellular network, or satellite communications systems may be used to insure continuous communications and control of all wind turbines, energy storage, and grid dispatchment components of the current invention.

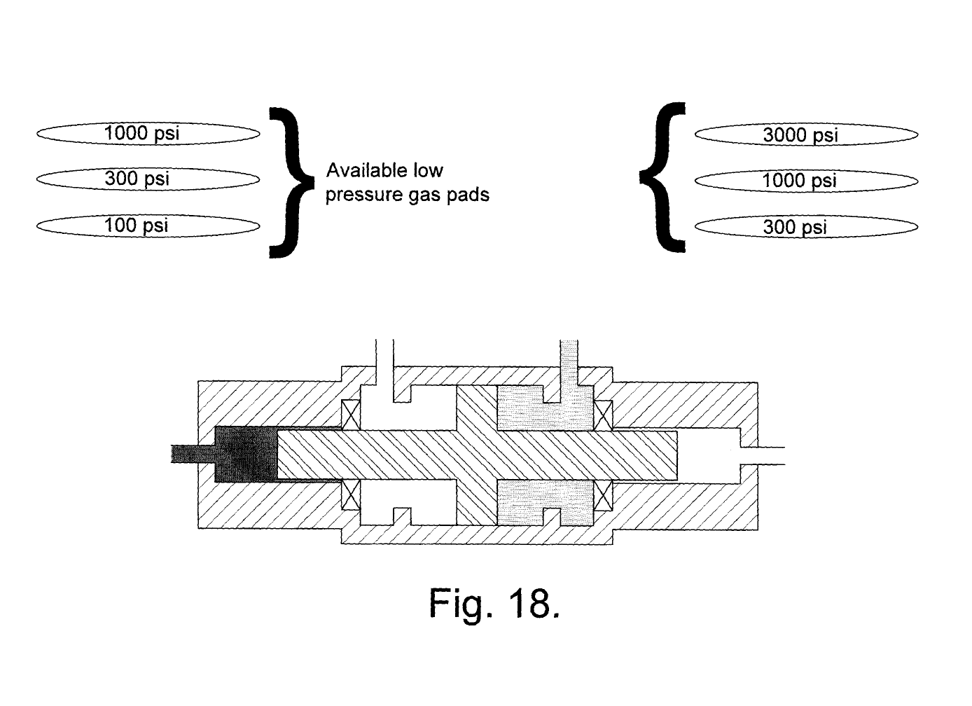

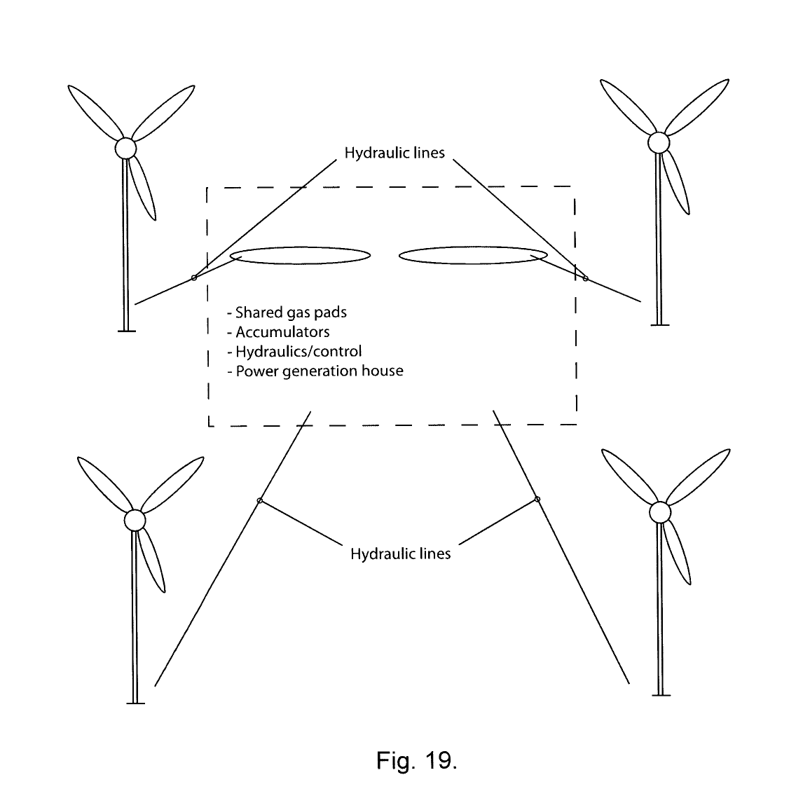

FIG. 18 show configurations of available low pressure and high pressure gas pads a shuttle configuration. FIG. 19 shows a storage/control/generation sharing arrangement.

### APPENDIX

Concept: Variable displacement motor pump combination to isolate 3:1 pressure fluctuations from rest of circuit.

1) Please explain how the stored energy will be converted to electricity. How efficient do you expect this to be relative to the overall process?

2) Can you please step through the operation of the storage system

and delivery of power during the operating cycle.

We have considered at least three mechanisms for the storage and retrieval of energy. Each mechanism is appropriate at a certain scale. The simplest mechanism is a straight accumulator on the hydraulic circuit which stores energy by compressing a volume of gas as hydraulic fluid is pumped. When the fluid is allowed to discharge there is very little loss of energy.

The system we are constructing according to our proposal for SDTC is the intermediate sized mechanism which emulates the performance of an accumulator but which does not require such large volumes of hydraulic fluid.

The mechanical energy captured by the rotor on the wind turbine is used to drive a Hagglunds motor which we are using as a fixed displacement pump.

As a fixed displacement pump the Hagglunds is capable of offering a high torgue resistive load to the rotor at an appropriate horsepower level.

The Hagglundss at higher operating pressures is highly efficient in converting the rotory motion to fluid flow and will produce up to 5000 PSI and up to 600 gal/min at 97% efficiency.

This fluid flow is then used in a “closed loop” configuration driving one or several variable displacement hydraulic motors. While the Hagglunds operates at rotational speeds of between 0 and 45 rpm, and input torques of between 6000 and 300,000 foot pounds, with approximate fluid displacement of 25 gal per rotation, each of the variable displacement motors has a displacement of between 0.02 and 0.2 gals per rotation.

These variable displacement motors each then (more or less) operate as the output side of a fluid transmission system and rotate at speeds chosen to be approximately 1800 rpm.

Attached to each of the hydraulic motors in the storage system is a hydraulic pump (actually just another motor used as a pump). These motors are also variable displacement. The variable displacement pump has its displacement cycled so that the pressure delivered to the shuttles is matched to pressure required to compress and shuttle the gas from the low pressure reservoir to the high pressure reservoir.

Each shuttle is effectively a hydraulic double acting piston. The rod from the piston is used to first draw in gas from the low pressure reservoir on the intake side, and then when the chamber is full, and the piston action reverses, it is used to 1st compress and then shuttle the gas into the high pressure reservoir.

Both reservoirs start with a pressure of approximately 2400 psi, and the gas is drawn out of the larger low pressure reservoir, compressed, and transferred to the high pressure reservoir so that ultimately they end up in the operating range of 4800 psi on the high side and 1200 psi on the low side.

The reservoirs are fibre glass wrapped ⅜ wall x-75 pipe fabricated to the same standard as Trans Canada has proven and used for 5000 psi operation.

To extract the energy the operation is effectively reversed. The pump that was driving each shuttle becomes a motor driven by the hydraulic fluid pushed by the gas in the shuttle.

The displacement of the variable displacement motor is cycled so that its power level remains relatively constant through the 3:1 or 4:1 pressure variation that will occur with the expansion of the gas in the shuttle.

Operating at a relatively constant power level this variable displacement motor is then used to drive a variable displacement pump which again cumulates the fluid in the dosed loop system that in storage mode includes the Hagglunds.

In retrieval mode the dosed loop goes between the variable displacement pumps coming from the storage, and the variable displacement motors driving the generators.

In terms of an electrical analogy each of the variable displacement motor/variable displacement pump couples acts as “fluid transformer” so that the pressure/flow combination can be rebalanced as required from one side to the other.

In energy storage mode they are used first to mitigate the natural saw tooth pressure cycle induced by the shuttle compression/expansion mechanism, and second to match the dosed loop pressure to what is suitable.

The dosed loop pressure when the Hagglunds is filling the energy reservoirs originates with the wind, and so is unpredictable.

The closed loop pressure in the draining of the energy reservoir will usually be choosen for efficient operation of the generators.

This entire operation is far easier to visualize with an accumulator which has the same effect

With a straight accumulator the storage/retrieval efficiency is close to 95%.

The motor-generator pair involved introduces a 20% loss, so the efficiency is approximately 75%.

There is an additional 15% loss in the hydraulic motor used with the generator so the overall efficiency is about 60%.

With a simple accumulator mechanism which will not scale up as well. the overall efficiency is about 73%.

The overall efficiency of the turbine from the stand point of mechanical energy in to electrical energy out about 78%

Because the hydraulic/storage features of the wind turbine allow it to capture more energy at the rotor shaft (it does not need to feather out as quickly as a conventional turbine) so that the capacity factor is expected to be 20% higher than a regular turbine these numbers need to be scaled so that the “apples to apples” efficiency numbers become about 72% for the system with the shuttle, about 88% for the system with an accumulator and 93% for the system as a wind turbine.

5) In order to deliver 1 MW of electricity, what do you estimate to be the nominal capacity of the wind turbine? Is this the value used in the capital estimate?

5. We are designing for 1 MW production capacity.

6) Business plan dated July 2008 references X-75 pipe rated for operating pressures of 3600 psi. Document titled ‘Basic Storage Calculations’ uses 4800 psi for the test case. Can you please discuss this difference and the impacts on project economics.

6. The pipe is highly preferably glass wrapped or another equivalent for handling the operating pressures. cm 1-9. (canceled)

10. A shuttle for an accumulator, the shuttle comprising:
a hydraulic cylinder having first and second hydraulic chambers,
a reversibly slidable piston disposed between the first and second hydraulic chambers,
a first gas reservoir connected to the gas port of the first hydraulic chamber,
a second gas reservoir connected to the gas port of the second hydraulic chamber.

11. The shuttle of claim 10, wherein the area of the surface of the piston in contact with the fluid in the first chamber is greater than the area of the surface of the piston in contact with the fluid in the second chamber.

12. A shuttle circuit comprising a shuttle having a hydraulic cylinder with first and second hydraulic chambers and a reversibly slidable piston disposed between the first and second hydraulic chambers, a first low-pressure gas reservoir connectable to first or second gas ports corresponding to the first and second hydraulic chambers, and a second high-pressure gas reservoir connectable to first or second gas ports corresponding to the first and second hydraulic chambers.

13. A method of storing energy in an accumulator having a shuttle circuit, wherein in an initial configuration the first gas reservoir is connected to the first gas port open to the first hydraulic chamber and the second gas reservoir is connected to the second gas port closed to the second hydraulic chamber, the method comprising:
i) allowing the high-pressure hydraulic fluid to compress the gas in the second chamber and draw gas from the first reservoir into the first chamber until the gas pressure in the second chamber is equal to the gas pressure in the second reservoir;
ii) opening the gas port valve in the second chamber to permit flow of hydraulic fluid into the second reservoir;
iii) closing both gas ports;
iv) reversing the connections of the first and second reservoirs to the first and second chambers and opening the second chamber gas port;
v) allowing the high-pressure hydraulic fluid to compress the gas in the first chamber and draw gas from the second reservoir into the second chamber until the gas pressure in the first chamber is equal to the gas pressure in the first reservoir;
vi) opening the gas port valve in the first chamber to permit flow of hydraulic fluid into the first reservoir;
vii) closing both gas ports;
viii) repeating steps i) to vii) until a desired amount of energy is stored.

14. The method of claim 13, further comprising a heat exchanger to move heat produced from gas compression between first and second chambers.

15. The method of claim 13, further comprising local accumulators on the gas system.

16. The method of claim 13, further comprising local accumulators on the hydraulic system.

17. A method of generating electrical energy, the method comprising forcing hydraulic fluid through a hydraulic motor using high-pressure gas stored according to the method of claim 13.

18. The shuttle circuit of claim 13, wherein the volume of the high-pressure and low-pressure accumulator vessels is sufficient to permit storage of a volume of gas representing 30 seconds of full hydraulic pump output.

19. A system of energy storage, wherein at least one set of at least three shuttle circuits, each as claimed in claim 10, are provided.

20. The system of claim 19, wherein as a shuttle reaches its terminus in one direction, a second medially positioned shuttle is operated in parallel.

21. The system of claim 20, wherein the at least one set of at least three shuttles is at least two sets of at least three shuttles, a first set having a mechanical advantage designed for high wind speeds and a second set having a mechanical advantage designed for low wind speeds.

22. The system of claim 20, further comprising a plurality of reservoirs of different pressures.

23. The system of claim 20, wherein the reservoirs have pressures of between 200 and 400 bar, 100 and 200 bar, 25 and 75 bar, and 5 and 15 bar.

24-38. (canceled)
